(19) United States
(12) Patent Application Publication
(10) Pub. No.: US 2010/0322829 A1
(43) Pub. Date: Dec. 23, 2010

(54) PROCESS FOR MANUFACTURING A DEVICE OF HEAT EXCHANGER TYPE MADE OF CERAMIC, AND DEVICES OBTAINED BY THE PROCESS

(75) Inventor: Pierre Deny, Toulouse (FR)

Correspondence Address: YOUNG & THOMPSON, 209 Madison Street, Suite 500, Alexandria, VA, 22314, US

(73) Assignee: BOOSTEC S.A., Bazet (FR)

(21) Appl. No.: 12/528,538

(22) PCT Filed: Feb. 26, 2008
(86) PCT No.: PCT/FR08/50315

§ 371 Date: Oct. 13, 2009

(30) Foreign Application Priority Data
Feb. 27, 2007 (FR) 0753511

(51) Int. Cl. B01J 19/00; B21D 53/02; F28F 7/00

(52) U.S. Cl. 422/198; 29/890.03; 165/185

(57) ABSTRACT

A process for manufacturing a device of heat exchanger type made of ceramic with assembled plates, includes making plates made of ceramic whereof one or more includes a fluid circuit, polishing the faces intended to be applied against one another of the plates made of ceramic, applying the polished faces of the plates against one another to produce the desired tight assembly.

The present invention relates to a process for manufacturing a device of heat exchanger type made of ceramic. It also relates to devices of heat exchanger type made of ceramic.

Heat exchangers are understood as heat exchangers enabling thermal transfer between the ambient air and a fluid passing through the exchanger or between two fluids passing through the exchanger, also exchanger reactors using thermal transfer to cause a chemical reaction and also heat dissipaters for electronics.

Interests in using ceramic materials to construct such devices are numerous and well known. The principal example is the capacity to use these products in a very wide temperature range, and resistance to corrosion.

There are two main families of thermal exchanger devices, whereof the principles of construction and use are very different:
devices with tubes and calendars,
devices with assembled plates (or <<superposed layers>>).

The present invention refers to the field of devices with assembled plates.

The invention applies particularly to the manufacture of heat exchangers made of ceramic, formed by a set of face-to-face plates, also known as superposed layers. The invention applies to the manufacture of heat exchangers/thermal reactors/heat dissipaters made of silicon carbide. The use of the silicon carbide (SiC) also contributes resistance to corrosion to a greater extent than the majority of other ceramic materials, exchange conditions largely improved due to the thermal excellent conductivity of SiC.

A flat device is composed of several stacked plates. One or more plates comprise a fluid circulation circuit (liquid or gas), and a device for intake and discharge of fluid. The plates are arranged alternatively so that one stage is dedicated to circulation of the fluids to be processed, the following stage being dedicated to circulation of the fluid coolant (heating or cooling), and so on. An adequate configuration supplies each of the plates with the desired fluid.

Two fields of application of these devices are sought in particular by this invention, without the field of application of the invention being limited to these two fields:
the compact equipment utilised in chemical processes, generally continuous, where reactions and other treatments are carried out between small quantities of products (a few mm3 or cm3), as opposed to traditional systems where the products are processed discontinuously, for example in large agitated reactors of several hundreds of litres,
the cooling of electronic power components whereof the surface power increase requires ever greater needs.

There are numerous devices already known in the prior art. The principal difficulty encountered in manufacturing these devices is creating satisfactory tightness of the fluid circulation circuits so as to eliminate all risk of leakage, or mixing of different fluids. Tightness defect between the circuits is redhibitory in the case of this type of device. However, tightness is complex to obtain due to temperatures to which these devices can be subjected, also pressures of circulating fluids and the more or less corrosive environment of the application in which they are used.

The most conventional solution for resolving a tightness problem in thermal exchangers is as in other fields, the adding of seals, generally made of organic materials, separating the different circuits. Yet, this solution can apply only when there is material for the seal resistant to temperature and/or to corrosion of the application, which limits its usage.

Another solution known to date differing from the most conventional solution is described in the patent application of the company ESK No. WO2006029741 (Document D1). The process described is a high-temperature assembly process of plates made of silicon carbide. It consists of connecting several ceramic plates by the combined effect of temperature and pressure, and without contribution by third-party material. The pressure levels to be applied (of the order of a hundred MPa) apparently impose excellent contact between the plates to prevent breakage. The resulting exchanger forms a monolithic mechanical assembly, where the tightness function of the exchanger is ensured by the resulting mechanical seal. In fact, the mechanical liaison of the plates is obtained by welding the plates together by exerting pressure of a hundred MPa with a temperature of 1600° C. to 2000° C., at the same time resulting in tightness vis-à-vis the fluids circulating between the plates and mechanical connection between the plates. However, the steps of the process, rise in pressure and temperature, are long and costly in energy and burden the manufacturing process.

Document D2, patent application EP 0 362 594, which does not relate to an exchanger, also discloses a method for joining two pieces made of silicon carbide after polishing. The mechanical connection for joining the pieces is obtained in the same way as in document D1, that is, by making a joint obtained by hot pressure on the pieces with conditions of temperature and pressure similar to document D1. This technique has the same drawbacks as the technique described in D1.

All techniques known to date for making a device of exchanger type are complex due to the quality of the tightness to be obtained for this type of device and materials used. Document D1 is considered as the closest prior art, but the method proposed is complex and costly to perform as evident from the preceding paragraphs.

The aim of the present invention is to rectify the drawbacks of the prior art.

To resolve the problem of tightness of a device of thermal exchanger type, the present invention proposes unexpectedly for such an application a simple and inexpensive solution which goes against all solutions proposed to date. In fact, this solution makes no use of soldering or adding on a joint or bringing in third-party material or even the associated use of temperature and pressure to ensure tightness between the plates of the fluid circuits and vis-à-vis the exterior.

The applicant has broken away from known techniques which, as said, are complex to implement as well as costly, even though the latter produce good tightness.

The applicant had the idea of ensuring tightness of the device of heat exchanger type by means of adhesion of the clad parts of the plates forming the device. The mechanical joint between the two pieces is dissociated from the tightness function.

The object of the present invention is a process for manufacturing a device of heat exchanger type made of ceramic with assembled plates. According to the invention, the process consists of making plates made of ceramic, one of which comprises a fluid circuit, polishing the faces of the plates intended to be applied against one another, applying the polished faces of the plates against one another and thus producing the desired tight assembly.

More particularly the object of the present invention is a process for manufacturing a device of heat exchanger type made of ceramic with assembled plates, characterised in that it includes the following steps:
1. making at least two plates made of ceramic, whereof at least one comprises a fluid circuit,
2. polishing at least the two faces of the two plates made of ceramic intended to be applied against one another,
3. applying the polished faces of the two plates producing the desired tight assembly against one another.

Another object of the invention is a thermal exchanger obtained by the process, a thermal reactor obtained by the process, a heat dissipater obtained by the process.

Other particular features and advantages of the invention will emerge clearly from the following description and which is given by way of illustrative and non-limiting example and in reference to the figures, in which:

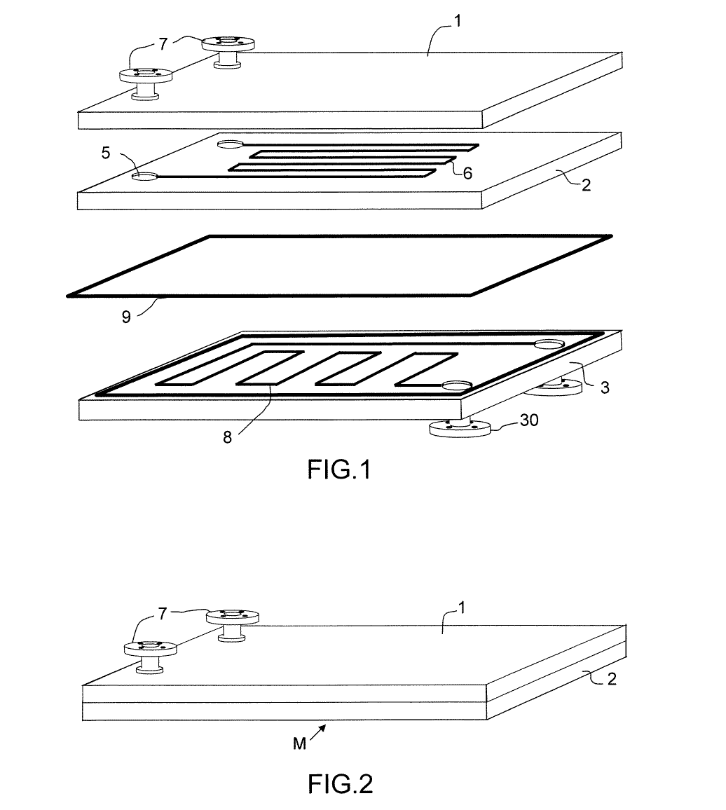

FIG. 1 illustrates an exploded view of a device of thermal exchanger type according to the invention,

FIG. 2 illustrates the two plates of FIG. 1, assembled according to the process of the invention, forming a ceramic module,

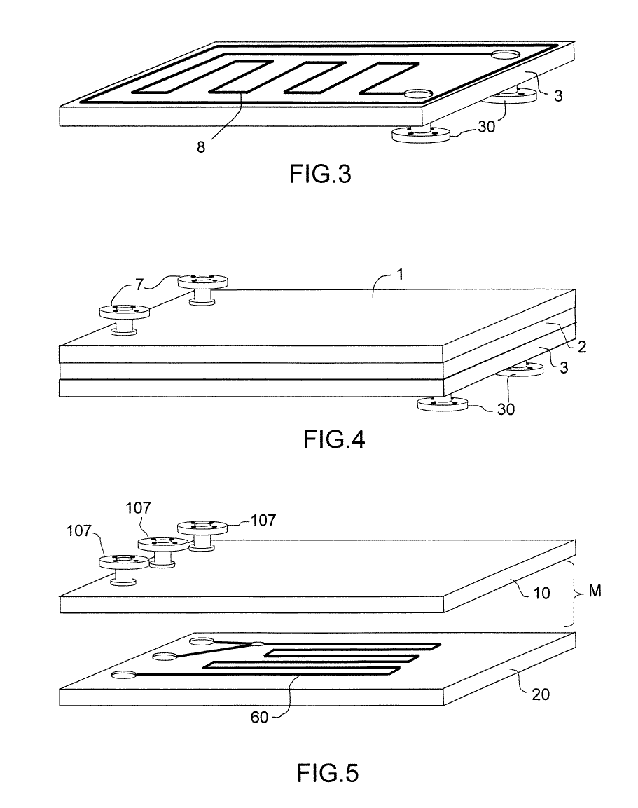

FIG. 3 illustrates a supplementary plate for making the thermal exchanger,

FIG. 4 illustrates the thermal exchanger made according to the process of the invention,

FIG. 5 illustrates the view of the plates in an exploded view for making a chemical reactor,

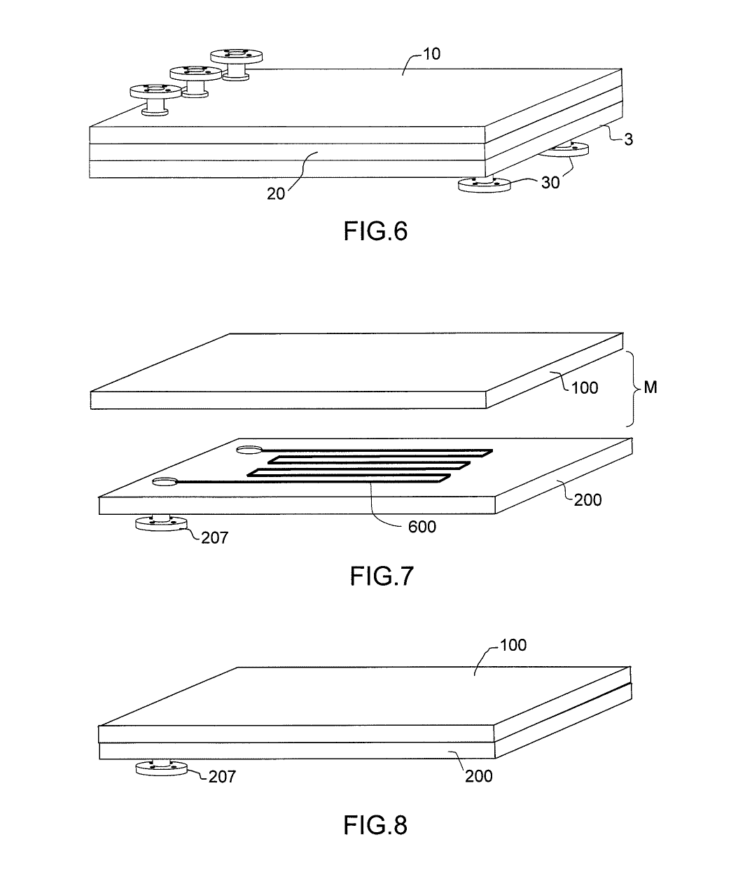

FIG. 6 illustrates the view of a reactor made according to the process of the invention,

FIG. 7 illustrates the exploded view of the plates for making a heat dissipater,

FIG. 8 illustrates the view of a heat dissipater made according to the process of the invention.

According to the present invention, the two polished faces of two plates 1, 2 made of ceramic are placed against one another, as illustrated by FIGS. 1 and 2 to produce a tight assembly, the plates thus being adhered by the smooth surfaces in contact.

As a function of the degree of polishing this adhesion is more or less strong and could be selected by the specialist, according to conditions of use of the device and its applications as a thermal exchanger or as reactor or heat dissipater. This sticking ensures the tightness of the fluid circulation circuits. The resulting tightness imposes no thermal stress or pressure to be employed. It also offers the specialist manufacturing flexibility, since he could adapt the degree of polishing according to need.

In fact, according to the preferred levels of pressure and tightness, simple mechanical pressure suffices to produce the desired tightness.

If there is greater need, sticking the two plates can be ensured by adhesion of the smooth faces to a greater degree. This is molecular adhesion, obtained when the surfaces to be stuck are sufficiently smooth, devoid of particles or contamination, and when they are sufficiently close to make contact, typically at a distance of less than a few nanometres. In this case, the attractive forces between the two surfaces are high enough to produce molecular adhesion.

Molecular adhesion is caused initially by all the attractive forces (Van der Waals forces) of electronic interaction between atoms or molecules of the two surfaces to be stuck. These attractive forces are all the more substantial since the distance between the two surfaces is small.

Perfect adhesion can be achieved at normal temperature and pressure, after polishing of the faces and as per the case after chemical cleaning of the surfaces to remove any impurity. The sticking energy force could however vary according to cleaning carried out prior to sticking, the optional addition of hydroxides to the surfaces, and the optional use of thermal treatment subsequent to sticking.

The steps employed by the process will now be described:

A raw blank is obtained by isostatic pressing, at 1400 bars for example, of submicronic silicon carbide powder to which are added the adequate additives to produce a ceramic.

Flat samples are machined in this blank to produce at least two plates 1, 2 made of desired ceramic, then sintered at high-temperature (around 2100° C.) in a vacuum oven.

The plates 1, 2 are then rectified on a flat grinder with a diamond grinding wheel.

The faces to be placed against one another are then ground and polished so as to produce flatness of less than 150 nm PV (PV abbreviation of the English expression <<Peak-to-Valley>>) and roughness of less than 1 nm RMS (RMS abbreviation of the English expression <<Root Mean Square >>).

The two others faces of the plates 1, 2 will also be ground then polished to the extent where they will be put in contact with other plates also ground then polished, as will be seen in the following examples.

The polishing operations can be carried out for example according to the following sequence:
ground on a rotary plate or metallic alloy grinder charged or not by diamonds. Use of a water-based polishing fluid or not containing diamond powder (grains of 50 to 20 μm),

polished on a rotary plate flat polisher made of metal alloy, organic polymer or textile. Use of a water-based polishing fluid or not containing diamond powder (grains of 10 to 1 μm).

Several operations can succeed one another in decreasing the size of the grains contained in the polishing fluid to produce the required characteristics of flatness and roughness.

After chemical cleaning, for example, the two plates 1, 2 are put in contact. A shearing assay at a value of 1500 N does not separate these two plates.

It is however possible to separate the plates using a tool without risk of deterioration.

The advantages of the invention are numerous:

Tightness is achieved without extra material, effectively guaranteeing resistance to corrosion of the device, strictly equivalent to that of the ceramic material used;

Also, the absence of extra material eliminates any problem of differential dilation between the extra material and the ceramic material. This advantage enables usage of the device over the widest possible range of use of the ceramic material in place of limiting this range, as is the case with the solutions of the prior art,

According to conditions of use, the device can be easily disassembled and reassembled, allowing all necessary cleaning interventions,

Since, according to the conditions of use, the system is assembled at normal temperature and without special conditions, there is easy impregnation of the circulation circuit by an optional catalyst required for the desired reaction by all means known to the specialist.

The execution of the process in accordance with three embodiments will now be illustrated.

### EXAMPLE 1

### Heat Exchanger Made of Silicon Carbide Illustrated by the Diagrams of FIGS. 1 to 4

Two plates of silicon carbide 1, 2 are made by machining in previously pressed blanks by isostatic pressing at 1400 bars, for example.

The upper plate 1 comprises flanges 7, for example to ANSI standard, necessary for connecting the exchanger, made during raw machining.

The fluid circulation circuit 6 to be processed is machined raw in the lower plate 2, such as defined by the specialist for proper realisation of the application.

The two plates 1, 2 are sintered, rectified, ground then polished on the faces to be in contact. The techniques used for sintering, rectification and polishing are well known in the manufacture of items made from silicon carbide.

The plates 1, 2 are then applied against one another to ensure tightness due to adhesion of the parts which are in contact.

The plates stuck in this way form a first tight module M comprising the fluid circuit to be processed.

Another plate 3, designed to ensure circulation of the coolant fluid, is made of a material adapted to the application:
metal or plastic material if the conditions of use (nature of the fluid, pressure, temperature) are compatible with these materials,
ceramic identical to the two main plates is there is need of dilation adjustment (for example, for high usage temperature).

The plate 3 is machined by the same technique as the plate 2 to make the coolant fluid circulation circuit 8.

The plate 3, FIGS. 1 and 3, comprises connecting flanges also made by classic techniques for processing ceramic.

This plate 3 is then assembled on the module M, FIG. 4. This assembly will be made as a general rule by traditional methods: sticking or joints 9 for example, to the extent where, as a general rule, the coolant fluid is not corrosive and the temperatures are compatible with known materials.

Of course, in conventional terms elements not shown here will be used to complete making of the thermal exchanger, such as a safety grip system (by rods and springs, for example), and an adapted casing.

This type of exchanger made of silicon carbide (SIC) is particularly well adapted to making exchangers for low flows. In fact, this low flow, associated with the excellent thermal conductivity of SiC, needs only a fairly short reaction length, and thus results in plates of limited bulk, typically a few tens or hundreds of cm². Such surface values are highly compatible with simple and trouble-free polishing.

### EXAMPLE 2

### Chemical Reactor Made of Silicon Carbide Illustrated by the Diagrams of FIGS. 5 and 6

The principle utilised is the same as in the first example above, the sole difference being that the ceramic plates 10, 20 are arranged so as to allow the inlet of two fluids before inducing the desired chemical reaction. The plate 10 comprises the connecting flanges 107. The plate 20 comprises the fluid circuit 60. The plate 3 and the flanges ensure the same function as the plate 3 and as the flanges 30 of FIGS. 3 and 4 relative to the thermal exchanger.

This type of reactor is particularly well adapted to low-flow producing reactors. In fact, this low flow, associated with the excellent thermal conductivity of SiC, needs only a fairly short reaction length, and thus results in plates of limited bulk, typically a few tens or hundreds of cm². Such surface values are highly compatible with simple and trouble-free polishing.

### EXAMPLE 3

### Heat Dissipater Made of Ceramic for Electronics (Cooling of Electronic Components) Illustrated by FIGS. 7 and 8

Two ceramic plates 100 and 200 are made by machining in previously pressed blanks (as in the preceding examples), by isostatic pressing at 1400 bars, for example.

The upper plate 100 is made of an electrically insulating ceramic, for example from alumina or aluminium nitride.

The lower plate 200 is made of the same ceramic as the upper plate 100, or made of silicon carbide if better thermal conductivity is necessary to benefit evacuation of calories.

The coolant fluid circulation circuit 600 is machined in this lower plate 200, such as defined by the specialist for proper realisation of the application. The plate 200 also comprises the flanges 207, for example to ANSI standard, necessary for connecting the dissipater.

The two plates 100, 200 are sintered, rectified, ground then polished on the two faces intended to be in contact.

The electronic components are installed on the upper plate 100, and are cooled by the liquid circulating in the dissipater.

In all the embodiments described hereinabove the ceramic plates which have received polishing treatment, then optional additional processing (cleaning) in keeping with the process, show a strong level of adhesion when they are applied against one another, and the bond between the two plates is leakproof.

1. A process for manufacturing a device of heat exchanger type made of ceramic with assembled plates, characterised in that it comprises the following steps:
1. making at least two plates made of ceramic, whereof at least one comprises a fluid circuit,
2. polishing at least the two faces of the two plates made of ceramic intended to be applied against one another,
3. applying the polished faces of the two plates against one another producing the desired tight assembly.

2. The process for manufacturing a device as claimed in claim 1, characterised in that the step consisting of polishing the faces of the plates made of ceramic comprises one or more repetitions of the following sequence:
ground on a grinder using a polishing fluid containing diamond powder formed from grains of 50 to 20 μm in diameter,
polished on a polisher using a polishing fluid containing diamond powder formed from grains de 10 to 1 μm in diameter,
to produce flatness of less than 150 nm and roughness of less than 1 nm RMS.

3. The process for manufacturing a device as claimed in claim 2, characterised in that the operation consisting of grinding the plates is performed on a ceramic or metal alloy rotary plate grinder charged or not by diamonds, the polishing fluid able to be water-based,
and in that,
the operation consisting of polishing the plates is performed on a rotary plate flat polisher made of metal alloy, organic polymer or textile, the polishing fluid being water-based or not.

4. The process for manufacturing a device as claimed in claim 1, characterised in that the operation consisting of making at least two plates of ceramic comprises the following steps:
producing a raw blank by isostatic pressing of powder of submicronic ceramic to which are added adequate additives to produce the desired the ceramic;
machining of flat samples in this blank to produce the plates (1, 2) made of ceramic, then sintering at high temperature (around 2100° C.) in a vacuum oven.

5. The process for manufacturing a device as claimed in claim 1, characterised in that the ceramic is silicon carbide.

6. A heat exchanger made of ceramic obtained by the process as claimed in claim 1, said exchanger comprising plates assembled by adhesion of the surfaces in contact.

7. The heat exchanger as claimed in claim 6, characterised in that the plates are made of silicon carbide.

8. A chemical reactor made of ceramic obtained by the process as claimed in claim 1, said reactor comprising assembled plates by adhesion of the surfaces in contact.

9. The chemical reactor as claimed in claim 8, characterised in that the plates are made of silicon carbide.

10. A heat dissipater made of ceramic obtained by the process as claimed in claim 1, said dissipater comprising assembled plates by adhesion of the surfaces in contact.

11. The heat dissipater as claimed in claim 10, characterised in that the plates are made of silicon carbide or one of silicon carbide and the other of alumina or aluminium nitride.
